(19) United States
(12) Patent Application Publication
(10) Pub. No.: US 2021/0142398 A1
(43) Pub. Date: May 13, 2021

(54) AUCTIONING DEVICE, AUCTIONING METHOD, AND STORAGE MEDIUM

(71) Applicant: NEC CORPORATION, Tokyo (JP)

(72) Inventor: Manao MACHIDA, Tokyo (JP)

(73) Assignee: NEC CORPORATION, Tokyo (JP)

(21) Appl. No.: 17/044,387

(22) PCT Filed: Apr. 25, 2018
(86) PCT No.: PCT/JP2018/016867

§ 371 Date: Oct. 1, 2020

(51) Int. Cl. G06Q 30/08; G06Q 10/10

(52) U.S. Cl. CPC G06Q 30/08; G06Q 10/10

(57) ABSTRACT

A bid reception means 81 receives a bid including one or more items from among a plurality of items which are bid candidates, from a bidder. A competition determination means 83 determines whether a received bid price for each item subjected to bidding is higher than a sale price of the item subjected to bidding, and decides to update a buyer of the item in the case where the bid price is higher than the sale price, based on buyer information including the buyer and the sale price of the item. A competing buyer rejection means 84, in the case where, when the decision is made to update the buyer, a bid price for at least one item from among a plurality of items corresponding to a same buyer is higher than a sale price of the item, updates the buyer of each of all the plurality of items to absence of a buyer. A bid reflection means 85, when the decision is made to update the buyer, updates the sale price of the item for which the bid price higher than the sale price is bid, to the bid price, and updates the buyer of the item to the bidder of the bid price.

### TECHNICAL FIELD

The present invention relates to an auctioning device, an auctioning method, and a storage medium having stored therein an auctioning program for receiving a bid for a combination of a plurality of items.

### BACKGROUND ART

A combinatorial auction is an auction in which bids can be placed not on single items but on combinations of a plurality of items. An example of a combinatorial auctioning method is described in Non Patent Literature (NPL) 1. With the method described in NPL 1, instead of determining prices and buyers of items so as to maximize profits, calculation is performed based on approximation, thus achieving a combinatorial auction with a lighter calculation load than a traditional combinatorial auction.

NPL 1 also describes an ascending-type combinatorial auctioning method with regard to pricing mentioned in the document. With the method described in NPL 1, an auctioneer of an auction uniformly increases the price of every item in each round, and each bidder declares, in each round, a combination of items which the bidder wants at the current item price.

For each item, if only one bidder declares that he or she wants the item in a round, the bidder declaring that he or she wants the item is given the right to purchase the item at the price in the round. This is repeated for each round. Once the right has been given for all items, the auction ends, and subsequently each bidder who has acquired the right purchases items by exercising the right. The price paid upon the exercise of the right is an output of a function whose input is “the maximum price from among the items purchased×the number of items purchased”.

Assuming the rationality of each bidder, the bidder will not, in the current round, newly declare an item which the bidder did not declare in the previous round. This is because the bidder who opted not to buy the item when it was cheaper is unlikely to buy it at a higher price. Therefore, the right to purchase one item will not be given to a plurality of bidders.

### CITATION LIST

### Non Patent Literature

Takayuki Ito, Makoto Yokoo, Shigeo Matsubara, Atsushi Iwasaki. A New Strategy-Proof Greedy-Allocation Combinatorial Auction Protocol and its Extension to Open Ascending Auction Protocol. In Proceedings of The Twentieth National Conference on Artificial Intelligence (AAAI-05), pp. 261-266, 2005.

### SUMMARY OF INVENTION

### Technical Problem

However, the method described in NPL 1 has a problem in that, when goods are substitutable for a plurality of bidders, item prices rise unreasonably. The reason for this is as follows: Assuming that each bidder considers a bid to be rational and a plurality of goods as substitute goods, with the method described in NPL 1, the plurality of bidders each make declaration for all substitute goods, as a result of which the right to purchase each item is not determined and the price of the item increases. This problem will be described below, using a specific example.

For example, suppose two bidders each consider two items A and B as having the same value (or consider buying only one of the items). With the method described in NPL 1, the two bidders each declare both of the items A and B in each round if the prices are not higher than the values they put on the items. The reason for this is as follows: While each bidder has the right to purchase only one of the items even if the bidder acquires the right to purchase both items, if the bidder does not declare one of the items, the bidder loses the chance of being able to purchase the item. Thus, the latter case poses only disadvantage.

On the other hand, if the two items A and B are provided on individual ascending auctions at the same timing, the two bidders can compare the prices of the two items and bid for only the cheaper item. This causes no price rise. It is desirable to avoid such a situation in which, even when the same item is provided, the price rises unreasonably depending on the auctioning system.

The present invention therefore has an object of providing an auctioning device, an auctioning method, and a storage medium having stored therein an auctioning program that can prevent unreasonable price rise when goods are substitutable for a plurality of bidders.

### Solution to Problem

An auctioning device according to the present invention includes: a bid reception means for receiving a bid including one or more items from among a plurality of items which are bid candidates, from a bidder; a competition determination means for determining whether a received bid price for each item subjected to bidding is higher than a sale price of respective ones of the item subjected to bidding, and deciding to update a buyer of the item in the case where the bid price is higher than the sale price, based on buyer information including the buyer and the sale price of the item; a competing buyer rejection means for, in the case where, when the decision is made to update the buyer, a bid price for at least one item from among a plurality of items corresponding to a same buyer is higher than a sale price of the item, updating the buyer of each of all the plurality of items to absence of a buyer; and a bid reflection means for, when the decision is made to update the buyer, updating the sale price of the item for which the bid price higher than the sale price is bid, to the bid price, and updating the buyer of the item to the bidder of the bid price.

An auctioning method according to the present invention is an auctioning method carried out by a computer, including: receiving a bid including one or more items from among a plurality of items which are bid candidates, from a bidder; determining whether a received bid price for each item subjected to bidding is higher than a sale price of respective ones of the item subjected to bidding, and deciding to update a buyer of the item in the case where the bid price is higher than the sale price, based on buyer information including the buyer and the sale price of the item; in the case where, when the decision is made to update the buyer, a bid price for at least one item from among a plurality of items corresponding to a same buyer is higher than a sale price of the item, updating the buyer of each of all the plurality of items to absence of a buyer; and when the decision is made to update the buyer, updating the sale price of the item for which the bid price higher than the sale price is bid, to the bid price, and updating the buyer of the item to the bidder of the bid price.

A storage medium having stored therein an auctioning program according to the present invention is a storage medium having stored therein an auctioning program for causing a computer to carry out: a bid reception process of receiving a bid including one or more items from among a plurality of items which are bid candidates, from a bidder; a competition determination process of determining whether a received bid price for each item subjected to bidding is higher than a sale price of respective ones of the item subjected to bidding, and deciding to update a buyer of the item in the case where the bid price is higher than the sale price, based on buyer information including the buyer and the sale price of the item; a competing buyer rejection process of, in the case where, when the decision is made to update the buyer, a bid price for at least one item from among a plurality of items corresponding to a same buyer is higher than a sale price of the item, updating the buyer of each of all the plurality of items to absence of a buyer; and a bid reflection process of, when the decision is made to update the buyer, updating the sale price of the item for which the bid price higher than the sale price is bid, to the bid price, and updating the buyer of the item to the bidder of the bid price.

### Advantageous Effects of Invention

According to the present invention, it is possible to prevent unreasonable price rise when goods are substitutable for a plurality of bidders.

### BRIEF DESCRIPTION OF DRAWINGS

FIG. 1 is a block diagram depicting an example of a structure of Exemplary Embodiment 1 of a combinatorial auctioning system according to the present invention.

FIG. 2 is a flowchart depicting an example of operation of the combinatorial auctioning system in Exemplary Embodiment 1.

FIG. 3 is a block diagram depicting an example of a structure of Exemplary Embodiment 2 of a combinatorial auctioning system according to the present invention.

FIG. 4 is a flowchart depicting an example of operation of the combinatorial auctioning system in Exemplary Embodiment 2.

FIG. 5 is an explanatory diagram depicting an example of seats in a hall to be auctioned.

FIG. 6 is an explanatory diagram depicting an example of values by two bidders.

FIG. 7 is an explanatory diagram depicting an example of progression of a combinatorial auction.

FIG. 8 is an explanatory diagram depicting an example of operation of a combinatorial auction described in NPL 1.

FIG. 9 is a block diagram depicting an overview of an auctioning device according to the present invention.

### DESCRIPTION OF EMBODIMENT

Exemplary embodiments of the present invention will be described below, with reference to the drawings.

### Exemplary Embodiment 1

FIG. 1 is a block diagram depicting an example of a structure of Exemplary Embodiment 1 of a combinatorial auctioning system according to the present invention. A combinatorial auctioning system 100 in this exemplary embodiment includes a bid reception unit 1, a buyer storage unit 2, a competition determination unit 11, a competing buyer rejection unit 12, a bid reflection unit 13, a salability notification unit 14, and a price display unit 15.

The bid reception unit 1 receives a bid including one or more items from among a plurality of items which are bid candidates, from a bidder 20. Herein, the “bid candidate” is a candidate item for an auction. An item for which a bidder wants to win a bid is also referred to as an “item subjected to bidding”. Specifically, the bid reception unit 1 may receive a bid for one item from the bidder 20, or receive a bid for a combination of a plurality of items from the bidder 20. Information indicating the bid (hereafter also referred to as “bid information”) includes each item subjected to bidding and a bid price for the item.

That is, the bid reception unit 1 in this exemplary embodiment may, even in the case where there are a plurality of substitutable items subjected to bidding, receive bid information of only part of the items.

The buyer storage unit 2 stores information (hereafter referred to as “buyer information”) including a buyer and sale price of each item. The buyer storage unit 2 stores the buyer information as the progress of the auction while sequentially updating it. The buyer storage unit 2 is implemented, for example, by a magnetic disk or the like.

The competition determination unit 11 compares the bid information received by the bid reception unit 1 and the buyer information stored in the buyer storage unit 2, determines whether the received bid price for each item subjected to bidding is higher than the sale price of the item, and decides whether to update the buyer based on the determination result. In the case where the bid price is higher than the sale price, the competition determination unit 11 decides to update the buyer. In the case where the received bid price of the item is not higher than the sale price, the competition determination unit 11 may instruct the below-described salability notification unit 14 to notify the bidder of an error.

The competing buyer rejection unit 12, in the case where the competition determination unit 11 decides to update the buyer, updates the buyer of the item subjected to bidding to the absence of a buyer. In other words, the competing buyer rejection unit 12 updates the buyer of the item for which the higher bid price than the sale price is bid, to the absence of a buyer.

As mentioned above, the bid reception unit 1 in this exemplary embodiment need not necessarily receive a bid for a plurality of items. Accordingly, there are cases where, from among a plurality of items for which one bidder bids in combination, a bid price bid by another bidder for at least one of the items exceeds the current sale price. In this case, the competing buyer rejection unit 12 in this exemplary embodiment performs a process of rejecting the bid for all of the plurality of items for which the one bidder bids in combination. Specifically, in the case where the bid price for at least one item from among the plurality of items corresponding to the same buyer is higher than the sale price, the competing buyer rejection unit 12 updates the buyer of each of all the plurality of items to the absence of a buyer.

Thus, in the case where one bidder wants only either one of items, the bidder can rebid for an item different from an item for which another bidder bids. Moreover, in the case where the bidder wants combined items, the bidder can rebid for the plurality of items in combination. This can prevent unreasonable rise of item prices. Furthermore, for a bidder who values combined items, a situation in which the bidder wins a bid for only part of the desired items can be prevented.

The bid reflection unit 13, in the case where the competition determination unit 11 decides to update the buyer, updates, for each item subjected to bidding, the buyer to the bidder, and the sale price to the bid price for the item. That is, the bid reflection unit 13 updates, for the item for which the bid price higher than the sale price is bid, the sale price to the bid price, and the buyer to the bidder of the bid price.

The bid reflection unit 13 may further add a predetermined amount of increase or rate of increase to the updated sale price, to calculate a biddable lowest price. The competition determination unit 11 may then determine whether a received bid price for each item is higher than the lowest price calculated based on the sale price.

Through cooperation of the foregoing components, the buyer can be updated according to the bid.

The salability notification unit 14 makes a salability notification to each bidder influenced by the update of the buyer. The influenced bidders include a bidder who has bid and become the new buyer, and a bidder who is no longer the buyer of the item as a result of the new bid. The salability notification unit 14 may notify the bidder using, for example, email, SMS (short message service), or a notification function in any social networking service.

The price display unit 15 displays the item price on a display device (not depicted). Specifically, the price display unit 15 displays the current item price, the bid price, and the buyer. The price display unit 15 may, for example, display the subsequent biddable lowest price for the sale price, to the bidder. Here, the price display unit 15 may perform the display in a state in which whether the bid price is for a combination of items or for an individual item is distinguishable. The price display unit 15 may, for example, display the item price on a display device such as a display.

The bid reception unit 1, the competition determination unit 11, the competing buyer rejection unit 12, the bid reflection unit 13, the salability notification unit 14, and the price display unit 15 are implemented by a central processing unit (CPU) in a computer operating according to a program (auctioning program). For example, the program may be stored in a storage unit (not depicted) included in the combinatorial auctioning system or a storage medium, with the CPU reading the program and, according to the program, operating as the bid reception unit 1, the competition determination unit 11, the competing buyer rejection unit 12, the bid reflection unit 13, the salability notification unit 14, and the price display unit 15.

Alternatively, the bid reception unit 1, the competition determination unit 11, the competing buyer rejection unit 12, the bid reflection unit 13, the salability notification unit 14, and the price display unit 15 may each be implemented by dedicated hardware. The program may be stored in any storage medium such as read only memory (ROM) or a storage device (not depicted). The combinatorial auctioning system may be implemented by a single device. In this case the, combinatorial auctioning system can be regarded as an auctioning device.

Operation of the combinatorial auctioning system in this exemplary embodiment will be described below. FIG. 2 is a flowchart depicting an example of operation of the combinatorial auctioning system in Exemplary Embodiment 1.

The bid reception unit 1 receives bid information from the bidder (step S11). The competition determination unit 11 compares the received bid information and the buyer information stored in the buyer storage unit 2, and determines whether the received bid price for each item is higher than the sale price (i.e. whether there is a competition) (step S12).

In the case where the bid information includes at least one item whose bid price is not higher than the sale price (step S12: No), the combinatorial auctioning system 100 ends the process. In this case, the salability notification unit 14 may notify the bidder that the bid is unsuccessful.

In the case where the bid price is higher than the sale price for all items included in the bid information (step S12: Yes), on the other hand, the competition determination unit 11 decides to update the buyer. Then, the competing buyer rejection unit 12 updates, for the current buyer of an item included in the bid information from among the buyer information stored in the buyer storage unit 2, each item corresponding to the buyer to the absence of a buyer (step S13). This update process is performed for all buyers.

The bid reflection unit 13 updates, in the buyer information stored in the buyer storage unit 2, the buyer of each item included in the bid information to the bidder and the sale price of the item to the bid price (step S14).

The effects according to this exemplary embodiment will be described below. As described above, in this exemplary embodiment, the bid reception unit 1 receives a bid including one or more items from among a plurality of items which are bid candidates, from a bidder. The competition determination unit 11 determines whether the received bid price for each item is higher than the sale price of the item, based on buyer information including the buyer and the sale price. In the case where the bid price is higher than the sale price, the competition determination unit 11 decides to update the buyer. When the competition determination unit 11 decides to update the buyer, in the case where the bid price for at least one item from among a plurality of items corresponding to the same buyer is higher than the sale price, the competing buyer rejection unit 12 updates the buyer of each of all the plurality of items to the absence of a buyer. Further, when the competition determination unit 11 decides to update the buyer, the bid reflection unit 13 updates the sale price of the item for which the bid price higher than the sale price is bid, to the bid price, and the buyer of the item to the bidder of the bid price.

Thus, when goods are substitutable for a plurality of bidders, unreasonable price rise can be prevented. Specifically, price rise can be prevented in the case where goods are substitutable for part of the bidders.

That is, in this exemplary embodiment, the competition determination unit 11 compares the current sale price and the bid price and accepts the bid only in the case where the bid price is higher, and the bid reflection unit 13 updates the buyer. Therefore, each time a bid is accepted, the price of the item subjected to bidding increases. Moreover, in this exemplary embodiment, the process by the competing buyer rejection unit 12 eliminates such a situation in which, when updating the buyer, each bidder continues to be the buyer of only part of a combination of items for which the bidder has bid.

Hence, if each bidder is rational, the bidder bids for a combination of a smallest number of items which the bidder wants. This is because bidding for many items only increases the possibility that the bidder becomes not the buyer of all items as a result of a subsequent bid by another bidder, and rebidding requires a higher bid price, which poses only disadvantage.

With a usual method, the bidder needs to participate in all rounds of the auction in order to acquire an item. In this exemplary embodiment, on the other hand, the bid reflection unit 13 updates a buyer according to a bid. Hence, the bidder can make a bid at any timing he or she likes before the auction end, and acquire the item. Therefore, in this exemplary embodiment, the bidder does not need to keep participating in the auction from the start to the end, unlike in the usual method. This saves the bidder time and trouble.

Furthermore, since the competing buyer rejection unit 12 eliminates such a situation in which each bidder continues to be the buyer for only part of a combination of items for which the bidder has bid, each bidder who values combinations of items can be prevented from suffering a loss. For example, suppose a bidder does not value item A or item B as a single item, but values a set of items A and B. In this case, by bidding the combination of items A and B, the bidder has no risk of becoming the buyer of only item A or only item B and paying for the item, and thus can be prevented from suffering a loss.

### Exemplary Embodiment 2

Exemplary Embodiment 2 of a combinatorial auctioning system according to the present invention will be described below. FIG. 3 is a block diagram depicting an example of a structure of Exemplary Embodiment 2 of a combinatorial auctioning system according to the present invention. A combinatorial auctioning system 200 in this exemplary embodiment includes a bid reception unit 1, a buyer storage unit 2, a competition determination unit 11, a competing buyer rejection unit 12, a bid reflection unit 13, a salability notification unit 14, a price display unit 15, and a bid conversion unit 16.

In detail, the combinatorial auctioning system 200 in this exemplary embodiment further includes the bid conversion unit 16, in addition to the structure of the combinatorial auctioning system 100 in Exemplary Embodiment 1. The competition determination unit 11, the competing buyer rejection unit 12, the bid reflection unit 13, the salability notification unit 14, and the price display unit 15 are the same as those in Exemplary Embodiment 1.

The bid reception unit 1 in this exemplary embodiment receives bid information from a bidder, as with the bid reception unit 1 in Exemplary Embodiment 1. The bid reception unit 1 in this exemplary embodiment may receive, as the bid information, not only a combination of an item subjected to bidding and a bid price for the item, but also a combination of a combination of bid items and a bid price relating to the combination of bid items.

The bid conversion unit 16 converts the bid information so that the competition determination unit 11 can perform the determination process. The bid information is information including an item subjected to bidding and a bid price for the item, as mentioned above. Given that the combinatorial auctioning system 200 receives a bid for combined items, there is a possibility that the bid information received by the bid reception unit 1 is represented by a combination of an item combination and a sum total of bid prices or a bid price for an individual item. The bid for the combination is not limited to the total amount. For example, the maximum bid price for an individual item may be used as the bid price for the combination, or “the maximum bid price for an individual item×the number of items in the combination” may be used as the bid price for the combination.

In view of this, the bid conversion unit 16 converts the received bid information including the plurality of items into a combination of bid prices for the respective items. Whether the bid price included in the received bid information is to be processed as the sum total of bid prices or as the bid price of an individual item may be determined beforehand depending on the form of reception.

As an example, suppose the received bid information includes a combination of items subjected to bidding and a bid price (total amount) for the combination of items. In this case, the bid conversion unit 16 may calculate the bid price for each item from the bid price for the combination, and add, to the bid information, information including the items subjected to bidding and the bid price for each of the items. As another example, suppose the received bid information includes a combination of items subjected to bidding and a bid price (bid price for an individual item) for the combination of items. In this case, the bid conversion unit 16 may write, over the combination of items and the bid price for the combination included in the bid information, information including the items subjected to bidding and the bid price for each of the items.

As another example, suppose the received bid information includes a combination of items subjected to bidding and a maximum bid price for an individual item. In this case, the bid conversion unit 16 may generate bid information in which the maximum bid price is set for all items subjected to bidding. Suppose the received bid information includes a combination of items subjected to bidding and information of “the maximum bid price for an individual item×the number of items in the combination” as a bid price. In this case, too, the bid conversion unit 16 may generate bid information in which a maximum bid price is set for all items subjected to bidding.

The bid reception unit 1, the competition determination unit 11, the competing buyer rejection unit 12, the bid reflection unit 13, the salability notification unit 14, the price display unit 15, and the bid conversion unit 16 are implemented by a CPU in a computer operating according to a program (combinatorial auctioning program).

Operation of the combinatorial auctioning system in this exemplary embodiment will be described below. FIG. 4 is a flowchart depicting an example of operation of the combinatorial auctioning system in Exemplary Embodiment 2. The bid reception unit 1 receives bid information from the bidder (step S11), as in Exemplary Embodiment 1. The bid conversion unit 16 converts the received bid information including a plurality of items into a combination of bid prices for the respective items (step S21). The subsequent process is the same as the process in steps S12 to S14 in FIG. 2.

As described above, in this exemplary embodiment, in addition to the structure in Exemplary Embodiment 1, the bid conversion unit 16 converts received bid information including a plurality of items into a combination of bid prices for the respective items. Thus, the subsequent bidding processes can be performed uniformly regardless of the format of bid information of combined items. In other words, in this exemplary embodiment, since the bid conversion unit 16 converts the bid information, the types of bid information transmittable by the bidder can be increased, with it being possible to save labor for the bidder.

For example, in the case where the bid conversion unit 16 is not included in the combinatorial auctioning system, the bidder needs to set, as bid information, a bid price for each item subjected to bidding. In this exemplary embodiment, on the other hand, it suffices for the bidder to set a combination of items subjected to bidding and a bid price for the combination. In detail, while the bidder needs to set “item A: bid price 2” and “item B: bid price 2” in Exemplary Embodiment 1, the bidder only needs to set “items A and B: bid price 2” in this exemplary embodiment.

A specific example according to the present invention will be described below. In this specific example, bidding for seats in a live music (concert) hall or the like will be described as an example of a combinatorial auction. FIG. 5 is an explanatory diagram depicting an example of seats in a hall to be auctioned. Suppose the right to see a concert or the like in the seats depicted in FIG. 5 is auctioned. In this case, for example, the following two evaluation axes are assumed to be used as criteria for a bidder (customer) to decide the value of a seat.

A first evaluation axis is whether the bidder can secure the required number of adjacent seats. A second evaluation axis is whether the bidder can secure a better seat. For a bidder who plans to see the concert or the like in a group or two or three, a combination of adjacent two or three seats has high value. For nearly all bidders, front seats have higher value than rear seats, and seats at the center have higher value than seats at the ends.

FIG. 6 is an explanatory diagram depicting an example of the values of seats A, B, and C in FIG. 5 in the opinion of each of two bidders. A bidder 1 plans to see the concert in a group of two, and considers that adjacent seats A and B or adjacent seats B and C have a value of “9” in price. In this example, it suffices for the bidder 1 to secure two seats, and accordingly the bidder 1 considers the value combining the seats A, B, and C to be the same as the value of the seats A and B or the value of the seats B and C.

A bidder 2 plans to see the concert alone, and it suffices for the bidder 2 to secure one seat. Here, the bidder 2 considers that the value of the seat B which is a center seat is higher than the value of another seat A or C by 1.

When bidding, each bidder (e.g. bidders 1 and 2) decides an item and a price so as to maximize the utility represented by the following Formula 1. The assumption of the utility represented by the following Formula 1 is called quasilinear assumption, and is a typical assumption in the field of mechanism creation and analysis of auctions.

(Utility)=(value of combination of items)−(price of combination of items) (Formula 1).

FIG. 7 is an explanatory diagram depicting an example of the progression of the combinatorial auction. In this specific example, it is assumed that a price of a combination of items is a maximum price of an item in the combination. This pricing is described in NPL 1 as an example. The combinatorial auctioning system according to the present invention can support any pricing for combinations of items. For example, the price of the combination of items may be the sum total of the prices of the items included in the combination, or “the maximum price for an item included in the combination×the number of items”.

In this specific example, the increment of a biddable price is set to 1. The “item price” in FIG. 7 denotes a minimum bid price for each item for the competition determination unit 11 to determine that the received bid price of the item is higher than the sale price. In this specific example, the start time of the auction is 9:00 and the end time of the auction is 9:30, as depicted in FIG. 7. The “time” in FIG. 7 denotes the time of each bid. In the column “bid”, “001” denotes the bidder 1, and “002” denotes the bidder 2. In the combinatorial auctioning system according to the present invention, a bid for an item is allowed at any timing from the start to end of the auction, and accordingly there is variation in time in FIG. 7.

First, the bid reception unit 1 receives a bid by the bidder 1 at 9:05, the bid reflection unit 13 updates the buyer of the items A and B to the bidder 1, and updates the price of the items A and B to 2. In the example depicted in FIG. 7, the numeric value following the colon in the columns “bid” and “buyer” is the price. For example, “A,B:1” in the column “bid” indicates that the bid price for the combination of the items A and B is 1. Moreover, “001:1” in the column “buyer” indicates that the sale price of the item in the corresponding column is 1 and the buyer is the bidder 1.

The price display unit 15 may perform display in a state in which whether the bid price is for a combination of items or for an individual item is distinguishable, as in the example in the column “bid” in FIG. 7. Such display eases recognition of whether there is demand for a combination of items.

Next, the bid reception unit 1 receives a bid by the bidder 2 at 9:12. The respective utilities of the bidder 2 when buying the items A, B, and C are as follows: the utility when buying the item A=the value “3” of the item A−the price “2” of the item A=1; the utility when buying the item B=the value “4” of the item B−the price “2” of the item B=2; and the utility when buying the item C=the value “3” of the item C−the price “1” of the item C=2. That is, a bid for the item B or C maximizes the utility. The bidder 2 may bid for any of the items B and C. In this example, the bidder 2 bids for the item B.

Once the bid reception unit 1 has received the bid from the bidder 2, the competing buyer rejection unit 12 updates the buyer of each of the items A and B whose buyer has been the bidder 1, to the absence of a buyer. After this, the bid reflection unit 13 reflects the bid for the item B in the sale information in the buyer storage unit 2. Such bids are repeated. At the end of the auction, the combination of the items A and B is sold to the bidder 1 at the price “3”, and the item C is sold to the bidder 2 at the price “1”.

To explain the effects according to the present invention, operation of a usual combinatorial auction will be described below. FIG. 8 is an explanatory diagram depicting an example of operation of the combinatorial auction described in NPL 1. To match the conditions to those in the specific example in FIG. 7, a price of a combination of items is set to be a maximum price of an item in the combination.

In the combinatorial auction described in NPL 1, while the prices of all items are being increased, each bidder declares a desired combination of items. In the example depicted in FIG. 8, the reason why the bidder 2 declares only the item B at the time of item price=3 is because of the following utility calculation results: utility=the value “3” of the item A−the price “3” of the item A=0; and utility=the value “3” of the item C−the price “3” of the item C=0.

At the time of item price=4, too, the bidder 1 equally bids for the combination of the items A, B, and C. This is because, even when the bidder acquires the right to purchase all items, by exercising the right for only the combination of the items A and B or only the combination of the items B and C, the utility is such that utility=the value “9” (the sum of the value “3” of the item A, the value “3” of the item B, and the value “3” of the item C) of the combination of items−the item price “4”=5>0.

In the usual combinatorial auction depicted in FIG. 8, after the auction end, the bidder 1 exercises the purchase right and the combination of the items A and B is sold to the bidder 1 at the price “4”, but the item C remains unsold.

Comparison between the price of each item in the case of using the combinatorial auctioning system according to the present invention depicted in FIG. 7 and the price of each item upon purchase right acquisition in the usual combinatorial auction depicted in FIG. 8 reveals that the price of each item is lower in the combinatorial auction according to the present invention.

An overview of the present invention will be described below. FIG. 9 is a block diagram depicting an overview of an auctioning device according to the present invention. An auctioning device 80 (e.g. combinatorial auctioning system 100) according to the present invention includes: a bid reception means 81 (e.g. bid reception unit 1) for receiving a bid including one or more items from among a plurality of items which are bid candidates, from a bidder; a competition determination means 83 (e.g. competition determination unit 11) for determining whether a received bid price for each item subjected to bidding is higher than a sale price of respective ones of the item subjected to bidding, and deciding to update a buyer of the item in the case where the bid price is higher than the sale price, based on buyer information including the buyer and the sale price of the item; a competing buyer rejection means 84 (e.g. competing buyer rejection unit 12) for, in the case where, when the decision is made to update the buyer, a bid price for at least one item from among a plurality of items corresponding to the same buyer is higher than a sale price of the item, updating the buyer of each of all the plurality of items to absence of a buyer; and a bid reflection means 85 (e.g. bid reflection unit 13) for, when the decision is made to update the buyer, updating the sale price of the item for which the bid price higher than the sale price is bid, to the bid price, and updating the buyer of the item to the bidder of the bid price.

With such a structure, when goods are substitutable for a plurality of bidders, unreasonable price rise can be prevented.

The auctioning device 80 (e.g. combinatorial auctioning system 200) may include a bid conversion means (e.g. bid conversion unit 16) for converting received bid information including a plurality of items into a combination of bid prices for the respective items. With such a structure, the types of bid information transmittable by the bidder can be increased, with it being possible to save labor for the bidder.

The bid reflection means 85 may add a predetermined amount of increase or rate of increase to the updated sale price, to calculate a biddable lowest price, and the competition determination means 83 may determine whether a received bid price for each item is higher than the lowest price calculated based on the sale price.

The auctioning device 80 may include a salability notification means (e.g. salability notification unit 14) for making a salability notification to a bidder (e.g. a bidder who has bid and become the new buyer, and a bidder who is no longer the buyer of the item as a result of the new bid) influenced by the update of the buyer.

The auctioning device 80 may include a price display means (e.g. price display unit 15) for displaying a current item price, a bid price, and a buyer, and the price display means may perform the display in a state in which whether the bid price is for a combination of items or for an individual item is distinguishable. With such a structure, whether there is demand for a combination of items can be easily recognized.

### INDUSTRIAL APPLICABILITY

The present invention is suitable for use in an auctioning device for receiving a bid for a combination of a plurality of items. Specifically, an auctioning device according to the present invention can be used for auctions of a plurality of related items (in particular, auctions of seats in concerts, sports viewing, airplanes, bullet trains, etc.).

### REFERENCE SIGNS LIST

1 bid reception unit
2 buyer storage unit
11 competition determination unit
12 competing buyer rejection unit
13 bid reflection unit
14 salability notification unit
15 price display unit
16 bid conversion unit
100, 200 combinatorial auctioning system

1. An auctioning device comprising a hardware processor configured to execute a software code to:
receive a bid including one or more items from among a plurality of items which are bid candidates, from a bidder;
determine whether a received bid price for each item subjected to bidding is higher than a sale price of respective ones of the item subjected to bidding, and decide to update a buyer of the item in the case where the bid price is higher than the sale price, based on buyer information including the buyer and the sale price of the item;
a competing buyer rejection means for, in the case where, when the decision is made to update the buyer, a bid price for at least one item from among a plurality of items corresponding to a same buyer is higher than a sale price of the item, update the buyer of each of all the plurality of items to absence of a buyer; and
a bid reflection means for, when the decision is made to update the buyer, update the sale price of the item for which the bid price higher than the sale price is bid, to the bid price, and update the buyer of the item to the bidder of the bid price.

2. The auctioning device according to claim 1,
wherein the hardware processor is configured to execute a software code to convert received bid information including a plurality of items into a combination of bid prices for the respective items.

3. The auctioning device according to claim 1, wherein the hardware processor is configured to execute a software code to:
add a predetermined amount of increase or rate of increase to the updated sale price, to calculate a biddable lowest price, and
determine whether a received bid price for each item is higher than the lowest price calculated based on the sale price.

4. The auctioning device according to claim 1, comprising
a salability notification means for making a salability notification to a bidder influenced by the update of the buyer.

5. The auctioning device according to claim 1, wherein the hardware processor is configured to execute a software code to
perform the display in a state in which whether the bid price is for a combination of items or for an individual item is distinguishable.

6. An auctioning method carried out by a computer, comprising:
receiving a bid including one or more items from among a plurality of items which are bid candidates, from a bidder;
determining whether a received bid price for each item subjected to bidding is higher than a sale price of respective ones of the item subjected to bidding, and deciding to update a buyer of the item in the case where the bid price is higher than the sale price, based on buyer information including the buyer and the sale price of the item;
in the case where, when the decision is made to update the buyer, a bid price for at least one item from among a plurality of items corresponding to a same buyer is higher than a sale price of the item, updating the buyer of each of all the plurality of items to absence of a buyer; and
when the decision is made to update the buyer, updating the sale price of the item for which the bid price higher than the sale price is bid, to the bid price, and updating the buyer of the item to the bidder of the bid price.

7. The auctioning method according to claim 6 carried out by the computer, comprising
converting received bid information including a plurality of items into a combination of bid prices for the respective items.

8. A non-transitory storage medium having stored therein an auctioning program for causing a computer to carry out:
a bid reception process of receiving a bid including one or more items from among a plurality of items which are bid candidates, from a bidder;
a competition determination process of determining whether a received bid price for each item subjected to bidding is higher than a sale price of respective ones of the item subjected to bidding, and deciding to update a buyer of the item in the case where the bid price is higher than the sale price, based on buyer information including the buyer and the sale price of the item;
a competing buyer rejection process of, in the case where, when the decision is made to update the buyer, a bid price for at least one item from among a plurality of items corresponding to a same buyer is higher than a sale price of the item, updating the buyer of each of all the plurality of items to absence of a buyer; and
a bid reflection process of, when the decision is made to update the buyer, updating the sale price of the item for which the bid price higher than the sale price is bid, to the bid price, and updating the buyer of the item to the bidder of the bid price.

9. The non-transitory storage medium having stored therein an auctioning program according to claim 8, the auctioning program causing the computer to carry out
a bid conversion process of converting received bid information including a plurality of items into a combination of bid prices for the respective items.
